(19) United States
(12) Patent Application Publication
(10) Pub. No.: US 2013/0047747 A1
(43) Pub. Date: Feb. 28, 2013

(54) CAPACITIVE PRESSURE SENSOR AND INPUT DEVICE INCLUDING THE SAME

(71) Applicant: Il Kweon JOUNG, Suwon (KR)

(72) Inventor: Il Kweon JOUNG, Suwon (KR)

(73) Assignee: SAMSUNG ELECTRO-MECHANICS CO., LTD.

(21) Appl. No.: 13/490,886

(22) Filed: Jun. 7, 2012

(30) Foreign Application Priority Data
Aug. 25, 2011 (KR) 10-2011-0085155

(51) Int. Cl. G01L 1/14

(52) U.S. Cl. 73/862.68

(57) ABSTRACT

There are provided a pressure sensor and an input device including the same. The pressure sensor includes: a first conductive substrate having flexibility; a second conductive substrate disposed in parallel with the first conductive substrate; and an elastic dielectric layer disposed between the first and second conductive substrates and including a plurality of structures having a pyramidal shape, wherein the structures of the elastic dielectric layer are deformed according to pressure applied to the first conductive substrate to generate a change in capacitance between the first and second conductive substrates. Accordingly, the pressure sensor is capable of efficiently sensing a small amount of pressure.

### CROSS-REFERENCE TO RELATED APPLICATIONS

This application claims the priority of Korean Patent Application No. 10-2011-0085155 filed on Aug. 25, 2011, in the Korean Intellectual Property Office, the disclosure of which is incorporated herein by reference.

### BACKGROUND OF THE INVENTION

1. Field of the Invention

The present invention relates to a capacitive pressure sensor and an input device including the same, and more particularly, to a capacitive pressure sensor capable of accurately sensing a minute change in capacitance according to pressure, and an input device including the same.

2. Description of the Related Art

A pressure sensor, a device generating an electrical signal according to external pressure, may be divided into a capacitive-type pressure sensor and a resistive-type pressure sensor, similar to touch screen technology that has recently been prominent. In particular, the capacitive-type pressure sensor has recently been widely used, as it may have excellent durability as compared to the resistive-type pressure sensor and may sense a magnitude of external pressure numerically, in which intensity of the pressure is reflected rather than simple 0 and 1 binary data being generated.

FIGS. 1A and 1B are views of a general pressure sensor. Referring to FIG. 1A, a perspective view of a general pressure sensor 100, the pressure sensor 100 includes two substrates 110 and 120 disposed in parallel with one another and a dielectric layer 130 disposed therebetween. The dielectric layer 130 may be formed of a material having a predetermined level of elasticity, and at least one of the substrates 110 and 120 may be a flexible substrate formed of a flexible material.

FIG. 1B is a cross-sectional view showing a cross section of the pressure sensor 100 shown in FIG. 1A. As described above, the dielectric layer 130 is disposed between the substrates 110 and 120 disposed in parallel with one another, and the dielectric layer 130 between the substrates 110 and 120 is pressed by external pressure, such that a distance between the substrates 110 and 120 is changed. The change in the distance between the substrates 110 and 120 maybe detected due to a change in capacitance generated between the substrates 110 and 120 through the dielectric layer 130, and the change in capacitance between the substrates 110 and 120 may be measured with an integrated circuit (IC), or the like, having a predetermined capacitance sensing circuit, such that a change in external pressure may be sensed.

However, as shown in FIGS. 1A and 1B, since the pressure sensor 100 according to the related art has a structure in which the entire space between the substrates 110 and 120 is filled with the dielectric layer 130, a distance between the substrates 110 and 120 is almost unchanged in the case that a minute amount of external pressure is applied. Therefore, it is significantly difficult to measure a change in voltage according to a minute change in external pressure, such that the overall performance of an input device using the pressure sensor 100 may be deteriorated.

### SUMMARY OF THE INVENTION

An aspect of the present invention provides a capacitive pressure sensor capable of accurately sensing even a minute amount of external pressure through disposing a dielectric layer having conical or poly-pyramidal patterns formed between a plurality of substrates provided in parallel with one another, and an input device including the same.

According to an aspect of the present invention, there is provided a pressure sensor including: a first conductive substrate having flexibility; a second conductive substrate disposed in parallel with the first conductive substrate; and an elastic dielectric layer disposed between the first and second conductive substrates and including a plurality of structures having a pyramidal shape, wherein the structures of the elastic dielectric layer are deformed according to pressure applied to the first conductive substrate to generate a change in capacitance between the first and second conductive substrates.

The structures of the elastic dielectric layer may have a conical shape.

The structures of the elastic dielectric layer may have a poly-pyramidal shape.

The first and second conductive substrates may have voltages having different levels applied thereto.

The second conductive substrate may have a voltage having a ground level applied thereto.

According to another aspect of the present invention, there is provided an input device including: a plurality of pressure sensors; and a circuit part sensing a change in capacitance generated in the plurality of pressure sensors, wherein each of the pressure sensors includes: a first conductive substrate having flexibility; a second conductive substrate disposed in parallel with the first conductive substrate; and an elastic dielectric layer disposed between the first and second conductive substrates and including a plurality of structures having a pyramidal shape.

The circuit part may sense a change in capacitance generated between the first and second conductive substrates due to deformation of the structures of the elastic dielectric layer by pressure.

The circuit part may include a charge pump circuit.

The circuit part may apply different voltages to the first and second conductive substrates and measure changes in the applied voltages to sense a change in capacitance between the first and second conductive substrates.

The plurality of pressure sensors may be disposed on a two-dimensional plane.

The circuit part may determine a coordinate of pressure applied to the two-dimensional plane, based on the change in capacitance sensed in the plurality of pressure sensors.

### BRIEF DESCRIPTION OF THE DRAWINGS

The above and other aspects, features and other advantages of the present invention will be more clearly understood from the following detailed description taken in conjunction with the accompanying drawings, in which:

FIGS. 1A and 1B are views showing a general pressure sensor;

FIG. 2 is a view showing a pressure sensor according to an embodiment of the present invention;

FIGS. 3A and 3B are views describing an operational principle of a pressure sensor according to an embodiment of the present invention;

FIG. 4 is a view showing a circuit sensing capacitance of a pressure sensor according to an embodiment of the present invention; and

FIG. 5 is a plan view showing an input device according to an embodiment of the present invention.

### DETAILED DESCRIPTION OF THE INVENTION

Embodiments of the present invention will be described in detail with reference to the accompanying drawings. These embodiments will be described in detail in order to allow those skilled in the art to practice the present invention. It should be appreciated that various embodiments of the present invention are different but are not necessarily exclusive. For example, specific shapes, configurations, and characteristics described in an embodiment of the present invention may be implemented in another embodiment without departing from the spirit and scope of the present invention. In addition, it should be understood that the positioning and arrangement of individual components in each embodiment maybe changed without departing from the spirit and scope of the present invention. Therefore, the detailed description provided below should not be construed as being restrictive. Similar reference numerals will be used to describe the same or similar functions throughout the accompanying drawings.

Hereinafter, embodiments of the present invention will be described in detail with reference to the accompanying drawings so that those skilled in the art may easily practice the present invention.

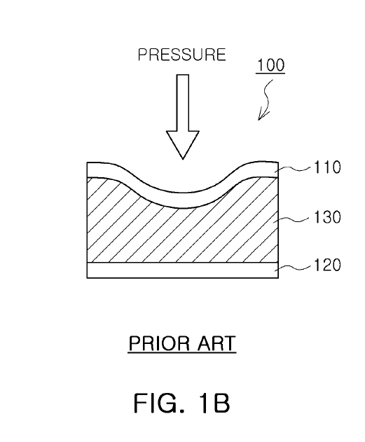

FIG. 2 is a view showing a pressure sensor according to an embodiment of the present invention. Referring to FIG. 2, corresponding to a perspective view of a pressure sensor 200 according to the embodiment of the present invention, the pressure sensor 200 may include first and second conductive substrates 210 and 220 disposed in parallel with one another and an elastic dielectric layer 230 disposed between the first and second substrates 210 and 220. As shown in FIG. 2, the elastic dielectric layer 230 may include a plurality of pyramidal structures.

The first and second conductive substrates 210 and 220 may include a conductive layer formed on a surface thereof contacting the elastic layer 230 or the substrates 210 and 220 may be entirely formed of a material (for example, copper) having conductivity. As needed, the first and second conductive substrates 210 and 220 may be manufactured by forming a conductive layer on a base film having high light transmissivity, such as polyethylene terephthalate (PET), polyimide (PI), polymethyl methacrylate (PMMA), or the like, using a transparent conductive material such as indium tin oxide (ITO), indium zinc oxide (IZO), zinc oxide (ZnO), carbon nanotubes, or the like.

At least one of the first and second conductive substrates 210 and 220 may be formed of a flexible material. Hereinafter, although it is assumed that the first conductive substrate 210 contacts apexes of the pyramidal structures of the elastic dielectric layer 230 and has flexibility and the second conductive substrate 220 contacts lower surfaces of the pyramidal structures of the elastic dielectric layer 230 throughout the specification for convenience of explanation, the present invention is not limited thereto.

The elastic dielectric layer 230 may be formed of a material having a predetermined level of elasticity and permittivity. For example, the elastic dielectric layer 230 may be formed of a material such as polydimethylsiloxane (PDMS), silicon, or the like. The pyramidal structure 235 provided in the elastic dielectric layer 230 may be a structure having a conical shape or a poly-pyramidal shape, such as a triangular pyramid, a quadrangular pyramid, or the like.

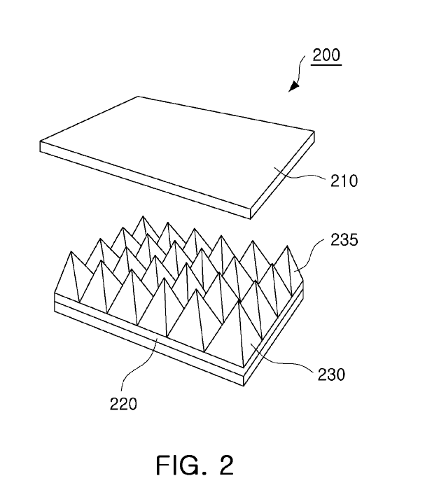

FIGS. 3A and 3B are views illustrating an operational principle of the pressure sensor according to the embodiment of the present invention. Referring to FIG. 3A, each of the first and second conductive substrates 210 and 220 may have a predetermined level of voltage applied thereto. The voltages applied to the first and second conductive substrates 210 and 220 may have different levels, and capacitance C, represented in Equation 1 as the permittivity of the elastic dielectric layer 230 and a distance between the first and second conductive substrates 210 and 220, may be generated between the first and second conductive substrates 210 and 220.

$$C = ɛ \frac{A}{d} \qquad [ Equation 1 ]$$

C: Capacitance between the first and second conductive substrates 210 and 220

A: Area between the first and second conductive substrates 210 and 220

d: Distance between the first and second conductive substrates 210 and 220

∈: Permittivity of the elastic dielectric layer 230

As shown in Equation 1, the capacitance generated in the elastic dielectric layer 230 may be determined by the facing area and the distance between the first and second conductive substrates 210 and 220 as well as by the permittivity of the elastic dielectric layer 230. Here, since the permittivity of the elastic dielectric layer 230 and the area between the first and second conductive substrates 210 and 220 are unchanged after the pressure sensor 200 is manufactured, a change in capacitance according to pressure may be determined by the distance d between the first and second conductive substrates 210 and 220.

Referring to FIG. 3B, as force is applied to the pressure sensor 200, a portion 215 of the first conductive substrate 210 having flexibility may be deformed to press the elastic dielectric layer 230 and the pyramidal structure 235 may be indented due to the force. Therefore, the distance between the first and second conductive substrates 210 and 220 is decreased in the deformed portion 215 to thereby increase capacitance, such that total capacitance may be changed to C′. At least one of the first and second conductive substrates 210 and 220 may be connected to a circuit part having a sensing circuit, wherein the circuit part may sense the change in capacitance between the first and second conductive substrates 210 and 220. For example, the circuit part may sense a change in capacitance according to pressure by measuring a change in voltages respectively applied to the first and second conductive substrates 210 and 220.

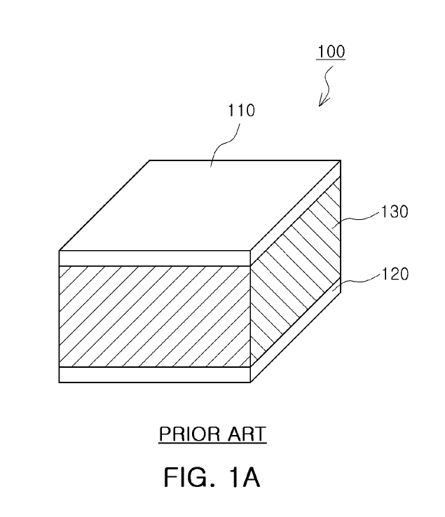

Unlike the pressure sensor 100 according to the related art shown in FIG. 1, since the elastic dielectric layer 230 of the pressure sensor 200 according to the embodiment of the present invention may be provided with the plurality of pyramidal structures 235, the distance between the first and second conductive substrates 210 and 220 may be significantly changed with even a small amount of pressure applied thereto. Particularly, the apex of the structure 235 contacts the first conductive substrate 210 to which pressure is directly applied, such that a large change in thickness may be generated even with a slight amount of pressure.

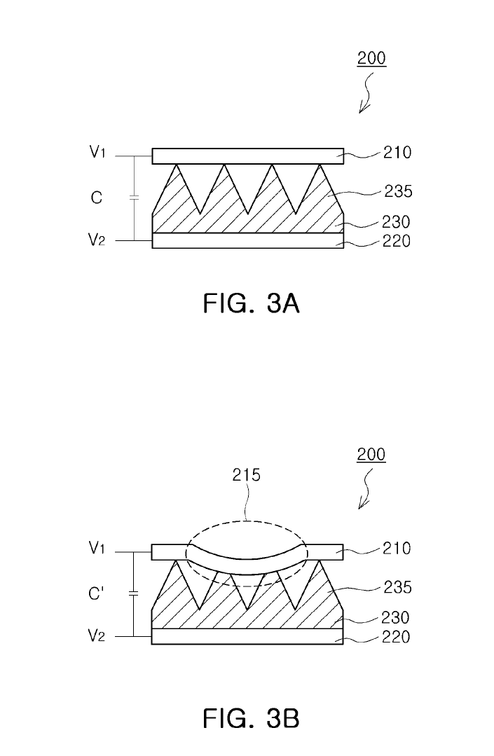

The circuit part electrically connected to the pressure sensor 200 may include a charge pump circuit in order to sense the change in capacitance. Hereinafter, a detailed description will be provided with reference to a circuit diagram of FIG. 4.

FIG. 4 is a view showing a circuit sensing capacitance of the pressure sensor according to the embodiment of the present invention. Referring to FIG. 4, a capacitance sensing circuit 400 according to the present embodiment may include an electric charge source 410, a first capacitor 420, a second capacitor 430, a buffer 440, an analog to digital converter (ADC) 450, and first and second switches 460 and 470. It may be understood that the first capacitor 420 which is a source capacitor charged by the electric charge source 410 may supply an electric charge to the second capacitor 430, and the second capacitor 430 may correspond to the change in capacitance generated in the pressure sensor 200.

When the first switch 460 is closed and the second switch 470 is opened, the first capacitor 420 may be charged by the electric charge source 210. When the charging of the first capacitor 420 is completed, the first switch 460 is opened, the second switch 470 is closed, and the electric charges are redistributed between the first and second capacitors 420 and 430, such that some of the electric charges may move from the first capacitor 420 to the second capacitor 430. A quantity of electric charges moving to the second capacitor 430 may be determined according to capacitance values of the first and second capacitors 420 and 430.

When the redistribution of the electric charges between the first and second capacitors 420 and 430 is completed, the buffer 450 measures voltage at a node at which the first and second capacitors 420 and 430 are connected to one another, such that a change in capacitance of the pressure sensor 200 may be calculated. Since the capacitance of the pressure sensor 200, in a state in which pressure is not applied thereto, is a value fixed in advance, as a difference between a capacitance value calculated from the voltage measured in the buffer 450 and a capacitance value fixed when pressure is not applied increases, the application of a large amount of pressure may be sensed.

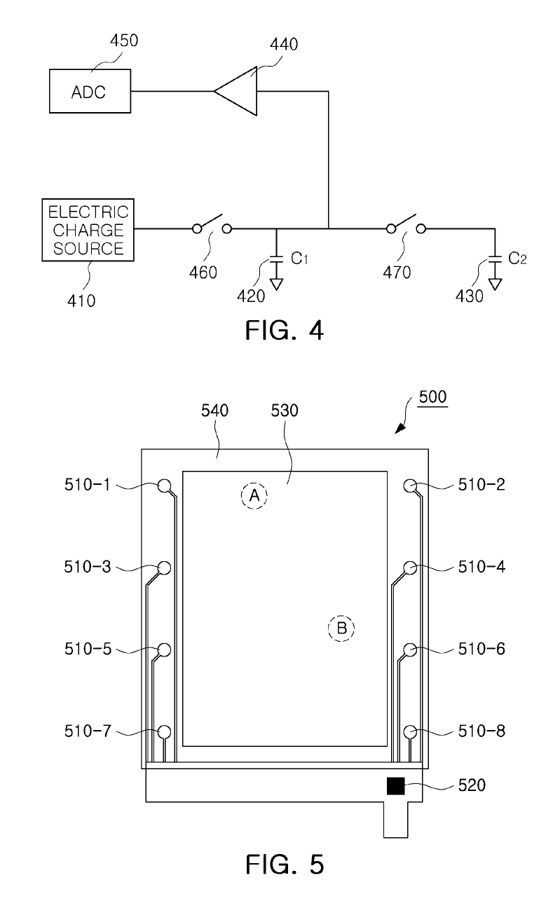

FIG. 5 is a plan view showing an input device according to the embodiment of the present invention. Referring to FIG. 5, it is assumed that an input device 500 according to the present embodiment is a device provided integrally with a display device such as a touch screen. In addition, the input device 500 may include a plurality of pressure sensors 510 disposed along a bezel part of an edge thereof. In the case in which the input device 500 is not provided integrally with the display device unlike the case shown in FIG. 5, the input device 500 may also include the pressure sensors 510 provided in a structure such as a matrix on a two-dimensional plane.

The plurality of pressure sensors 510, disposed along the bezel part of the edge of the input device 500, may be connected to a circuit part 520 including a capacitance sensing circuit through a wiring pattern formed of a conductive material. The circuit part 520 may be implemented as an integrated circuit to thereby be packaged as a single chip and may be mounted on a printed circuit board (PCB) having a connector to thereby be connected to an external main controller, or the like, so as to communicate therewith.

When pressure is applied to a specific region of the input device 500, changes in capacitance may be generated in each of the plurality of pressure sensors 510. Since the plurality of pressure sensors 510 are respectively connected to a plurality of channels provided in the circuit part 520, the circuit part 520 may measure changes in capacitance generated in the individual pressure sensors 510 as voltage values. Data obtained in each channel may be used to measure a position to which pressure is applied.

For example, as shown in FIG. 5, when it is assumed that pressure is applied to point A, a change in capacitance may be substantially similar and relatively high in first and second pressure sensors 510-1 and 510-2 and may be relatively low in a third to eighth pressure sensors 510-3 through 510-8. When pressure is applied to point B, a change in capacitance may be relatively high in the fourth and sixth pressure sensors 510-4 and 510-6 and may be relatively low in the other pressure sensors 510-1 to 510-3, 510-5, 510-7 and 510-8.

As described above, since the changes in capacitance detected in each of the plurality of pressure sensors 510 are different according to a point to which pressure is applied, two-dimensional coordinates of the point to which pressure is applied may be calculated. In addition, since a magnitude of pressure may be measured from the sum of the changes in capacitance measured in all of the pressure sensors 510, various input methods and user interfaces may be implemented.

As set forth above, in a pressure sensor according to embodiments of the present invention, an elastic dielectric layer provided with a plurality of pyramidal structures is disposed between first and second conductive substrates, such that a thickness of the dielectric layer may be easily changed, even when a small amount of external pressure is applied thereto, whereby even a minute amount of pressure may be accurately sensed.

While the present invention has been shown and described in connection with the embodiments, it will be apparent to those skilled in the art that modifications and variations can be made without departing from the spirit and scope of the invention as defined by the appended claims.

What is claimed is:

1. A pressure sensor comprising:
a first conductive substrate having flexibility;
a second conductive substrate disposed in parallel with the first conductive substrate; and
an elastic dielectric layer disposed between the first and second conductive substrates and including a plurality of structures having a pyramidal shape,
wherein the structures of the elastic dielectric layer are deformed according to pressure applied to the first conductive substrate to generate a change in capacitance between the first and second conductive substrates.

2. The pressure sensor of claim 1, wherein the structures of the elastic dielectric layer have a conical shape.

3. The pressure sensor of claim 1, wherein the structures of the elastic dielectric layer have a poly-pyramidal shape.

4. The pressure sensor of claim 1, wherein the first and second conductive substrates have voltages having different levels applied thereto.

5. The pressure sensor of claim 4, wherein the second conductive substrate has a voltage having a ground level applied thereto.

6. An input device comprising:
a plurality of pressure sensors; and
a circuit part sensing a change in capacitance generated in the plurality of pressure sensors,
wherein each of the pressure sensors includes:
a first conductive substrate having flexibility;
a second conductive substrate disposed in parallel with the first conductive substrate; and
an elastic dielectric layer disposed between the first and second conductive substrates and including a plurality of structures having a pyramidal shape.

7. The input device of claim 6, wherein the circuit part senses a change in capacitance generated between the first and second conductive substrates due to deformation of the structures of the elastic dielectric layer by pressure.

8. The input device of claim 6, wherein the circuit part includes a charge pump circuit.

9. The input device of claim 6, wherein the circuit part applies different voltages to the first and second conductive substrates and measures changes in the applied voltages to sense a change in capacitance between the first and second conductive substrates.

10. The input device of claim 6, wherein the plurality of pressure sensors are disposed on a two-dimensional plane.

11. The input device of claim 10, wherein the circuit part determines a coordinate of pressure applied to the two-dimensional plane, based on the change in capacitance sensed in the plurality of pressure sensors.
